(19) United States
(12) Patent Application Publication
(10) Pub. No.: US 2026/0359513 A1
(43) Pub. Date: Nov. 12, 2026

(54) ELECTROMECHANICAL MODELING OF COMPONENTS FOR POWER BOX DESIGN

(71) Applicant: Lam Research Corporation, Fremont, CA (US)

(72) Inventors: Prajwal S L SHETTY, Sakleshpura (IN); Kiran Kumar VALLABHANENI, Bengaluru (IN); Kota Chalukya BHAT, Bengaluru (IN)

(21) Appl. No.: 19/130,283

(22) PCT Filed: Nov. 14, 2023
(86) PCT No.: PCT/US2023/079709

§ 371 Date: May 15, 2025

Related U.S. Application Data
(60) Provisional application No. 63/386,234, filed on Dec. 6, 2022.

(51) Int. Cl. G06F 30/20; G06F 119/06; G06F 119/08; H01H 71/16

(52) U.S. Cl. CPC G06F 30/20; H01H 71/16; G06F 2119/06; G06F 2119/08

(57) ABSTRACT

One example provides, a method of generating an electrical twin for a power system component of a power box. The method comprises building a computer implemented mechanical model of the power system component for one or more of a range of load currents or a range of ambient temperatures. The method further comprises performing simulations of the computer implemented mechanical model across the one or more of the range of load currents or the range of ambient temperatures. The method further comprises generating modeled physical data of the power system component based on the simulations of the computer implemented mode. The method further comprises building the electrical twin of the power system component based at least on the modeled physical data.

### BACKGROUND

Processing tools are used in semiconductor manufacturing to perform chemical and/or physical processes on silicon substrates. A processing tool uses a power box comprising power system components to supply and control electrical power to various components of the processing tool. Examples of power system components include solid-state relays (SSR), circuit breakers, contactors and fuses.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

One example provides, a method of generating an electrical twin for a power system component of a power box. The method comprises building a computer implemented mechanical model of the power system component for one or more of a range of load currents or a range of ambient temperatures. The method further comprises performing simulations of the computer implemented mechanical model across the one or more of the range of load currents or the range of ambient temperatures. The method further comprises generating modeled physical data of the power system component based on the simulations of the computer implemented mechanical model. The method further comprises building the electrical twin of the power system component based at least on the modeled physical data.

In some such examples, the computer implemented mechanical model is alternatively or additionally configured to model a solid-state relay (SSR) and a heatsink.

In some such examples, performing the simulations of the computer implemented mechanical model across the one or more of the range of load currents or the range of ambient temperatures alternatively or additionally comprises performing a thermal analysis of the computer implemented mechanical model of the SSR and the heatsink across the one or more of the range of load currents or the range of ambient temperatures.

In some such examples, the method alternatively or additionally comprises determining a reduced order model of the modeled physical data, and building the electrical twin of the power system component based at least on the modeled physical data alternatively or additionally comprises building the electrical twin of the SSR based at least on the reduced order model.

In some such examples, the computer implemented mechanical model alternatively or additionally comprises a model of a circuit breaker comprising a bimetallic strip.

In some such examples, generating the modeled physical data of the power system component alternatively or additionally comprises generating deformation data of the bimetallic strip across the one or more of the range of load currents or the range of ambient temperatures.

In some such examples, generating deformation data of the bimetallic strip alternatively or additionally comprises performing a thermal-electric-structural analysis of the computer implemented mechanical model of the bimetallic strip across the one or more of the range of load currents or the range of ambient temperatures.

In some such examples, building the electrical twin of the power system component based at least on the modeled physical data alternatively or additionally comprises determining a deformation model based at least on the deformation data. The deformation model indicates at least rates of deformation across the range of load currents.

Another example provides a computing system. The computing system comprises a logic subsystem and a storage subsystem. The storage system comprises instructions executable by the logic subsystem to operate an electrical twin of a power system component. The electrical twin relates physical states of the power system component to one or more of a range of ambient temperatures or a range of load currents. The instructions are further executable to receive one or more of an ambient temperature or a load current for the power system component. The instructions are further executable to perform an electrical simulation to simulate evolution over time of the power system component for the one or more of the ambient temperature or the load current.

In some such examples, the electrical twin alternatively or additionally comprises an electrical twin of a solid-state relay (SSR) and a heatsink.

In some such examples, the instructions executable to perform the electrical simulation to simulate evolution over time of the power system component alternatively or additionally comprise instructions to simulate a component temperature over time of one or more of the SSR or the heatsink.

In some such examples, the electrical twin alternatively or additionally comprises an electrical twin of a circuit breaker comprising a bimetallic strip.

In some such examples, the instructions executable to perform the electrical simulation to simulate evolution over time of the power system component alternatively or additionally comprise instructions to simulate deformation of the bimetallic strip over time for the ambient temperature and the load current.

In some such examples, the instructions executable to use the electrical twin in the electrical simulation to simulate evolution over time alternatively or additionally comprise instructions to operate the electrical twin as an open circuit when the deformation of the bimetallic strip meets a trip threshold condition.

Another example provides, a method to simulate a power box. The method comprises operating an electrical twin of a power system component. The electrical twin relating physical states of the power system component to one or more of a range of ambient temperatures or a range of load currents. The method further comprises receiving one or more of an ambient temperature or a load current for the power system component. The method further comprises performing an electrical simulation to simulate evolution over time of the power system component for the one or more of the ambient temperature or the load current.

In some such examples, the electrical twin alternatively or additionally comprises an electrical twin of a solid-state relay (SSR) and a heatsink.

In some such examples, performing the electrical simulation to simulate evolution over time of the power system component alternatively or additionally comprises simulating a component temperature over time of one or more of the SSR or the heatsink.

In some such examples, the electrical twin alternatively or additionally comprises an electrical twin of a circuit breaker comprising a bimetallic strip.

In some such examples, performing the electrical simulation to simulate evolution over time of the power system component alternatively or additionally comprises simulating deformation of the bimetallic strip over time for the ambient temperature and the load current.

In some such examples, using the electrical twin in the electrical simulation to simulate evolution over time of the power system component alternatively or additionally comprises operating the electrical twin as an open circuit when the deformation of the bimetallic strip meets a trip threshold condition.

### BRIEF DESCRIPTION OF THE DRAWINGS

FIG. 1 shows a block diagram of an example processing tool.

FIG. 2 depicts a flow diagram of an example method of generating an electrical twin of a SSR and a heatsink.

FIG. 3 schematically shows an example computer implemented mechanical model of a SSR and a heatsink.

FIG. 4 shows a schematic view of an example electrical twin of the SSR and the heatsink of FIG. 3.

FIG. 5 depicts a flow diagram of an example method of generating an electrical twin of a circuit breaker.

FIG. 6 schematically shows an example computer implemented mechanical model of bimetallic strip of a circuit breaker.

FIG. 7 shows a schematic view of an example electrical twin of the computer implemented mechanical model of FIG. 6.

FIG. 8 depicts a flow diagram of an example method to design a power box utilizing an electrical twin of a power system component.

FIG. 9 shows a schematic view of an example electrical simulation utilizing the electrical twin of the SSR in FIG. 4.

FIG. 10 shows a schematic view of an example electrical simulation utilizing the electrical twin of the circuit breaker of FIG. 7.

FIG. 11 schematically shows an example evolution of a component temperature over time of the SSR in the electrical simulation of FIG. 9.

FIG. 12 schematically shows an example evolution of a deformation over time of a bimetallic strip of the circuit breaker in the electrical simulation of FIG. 10.

FIG. 13 depicts a block diagram of an example computing system.

### DETAILED DESCRIPTION

The term “ambient temperature” generally represents a temperature of air surrounding a power system component.

The term “bimetallic strip” generally represents, in a circuit breaker, an electrical connection comprising strips of two or more different metals joined in a face-to-face relationship. The different metals expand at different rates when heated, causing the bimetallic strip to deform. For example, the bimetallic strip is heated when the circuit breaker is operating in a fault condition.

The term “circuit breaker” generally represents an electrical device comprising a bimetallic strip. The bimetallic strip deforms when the circuit breaker is operating in a fault condition. When the deformation of the bimetallic strip meets a trip threshold condition, the circuit breaker operates as an open circuit.

The term “component temperature” generally represents a temperature of a power system component.

The term “computer implemented mechanical model” generally represents a virtual three-dimensional representation of a real-world power system component, including electrical, thermal, and structural characteristics of the power system component.

The term “constraint condition” generally represents an outer range of a desired operating point of a power system component.

The term “deformation” and variants thereof generally represent a change in shape of a bimetallic strip as a function of heating.

The term “deformation data” generally represents information relating to change in shapes of a bimetallic strip resulting from different ambient temperatures and/or load currents.

The term “deformation model” generally represents a set of one or more equations for determining a deformation magnitude of a bimetallic strip as a function of factors such as ambient temperature and load current.

The term “electrical simulation” generally represents a virtual representation of a circuit.

The term “electrical twin” generally represents a virtual circuit component representation of a power system component. The electrical twin relates physical states of the power system component to ambient temperatures and/or load currents for use in an electrical simulation.

The term “evolution over time” generally represents a change in a physical state of a power system component as a function of time from exposure to a load current and/or an ambient temperature.

The term “fault condition” generally represents an operation of a circuit breaker where a load current is greater than a rated current of the circuit breaker.

The term “heatsink” generally represents a thermally conductive mass that dissipates heat from a power system component, such as a solid-state relay.

The term “load current” generally represents a flow of electrical power through a power system component. The load current may be direct current or alternating current.

The term “modeled physical data” generally represents information determined from an analysis of a computer implemented mechanical model of a power system component.

The term “physical state” generally represents a physical condition of a power system component. Examples of physical states include a component temperature and a deformation magnitude.

The term “power box” generally represents a device that delivers and/or controls electrical power delivery to one or more components of a machine.

The term “power system component” generally represents an electrical device in a power box. The power system component may supply or control an output power of the power box. Examples of power system components include solid-state relays and circuit breakers.

The term “processing chamber” generally represents an enclosure in which chemical and/or physical processes are performed on substrates.

The term “processing tool” generally represents a machine including a processing chamber and other hardware configured to enable processing to be carried out in the processing chamber.

The term “rated current” generally represents an upper value of a range of load currents that a circuit breaker can conduct continuously at a specified ambient temperature. Operating conditions of the circuit breaker may derate the rated current to a different value. Examples of such operating conditions include different ambient temperatures and operating multiple circuit breakers adjacent to each other.

The term “reduced order model” generally represents a mathematical representation of modeled physical data obtained from a computer implemented mechanical model of a power system component. The reduced order model may be an approximation of the modeled physical data and have a lower complexity. For example, results from the computer implemented mechanical model (e.g., three-dimensional) may be reduced onto a two-dimensional perspective.

The term “solid-state relay (SSR)” generally represents an electronic device that controllably switches on or off an output power.

The term “substrate” generally represents any object onto which chemical and/or physical processes are performed in a processing chamber.

The term “thermal analysis” generally represents an analysis of a transient heat dissipation of a power system component as determined from a computer implemented mechanical model of the power system component.

The term “thermal-electric-structural analysis” generally represents an analysis of a deformation of a bimetallic strip resulting from an applied load current and/or ambient temperature determined from a computer implemented mechanical model of the bimetallic strip.

The term “tripping time” generally represents a duration of a circuit breaker operating in a fault condition until the circuit breaker operates as an open circuit, or trips.

The term “trip threshold condition” generally represents a situation where a bimetallic strip deforms to an extent that breaks an electrical connection in a circuit breaker.

A processing tool for processing substrates can include many different powered components. Circuitry for providing power to the powered components can be located in a power box. Some power box components can comprise electromechanical characteristics. Example electromechanical components include solid-state relays (SSRs) and circuit breakers. The electromechanical characteristics of such components can vary with different operating conditions, such as ambient temperatures and/or load currents, for example. However, during processing tool development and when troubleshooting, testing physical power boxes in different operating conditions may be time-consuming and costly.

To avoid testing physical power boxes in different operating conditions, a power box may be designed using electrical simulations. However, current simulation models of power system components are generally based on static operating conditions, such as a static load current or a static ambient temperature. Such static operating conditions may not reflect real-world operating conditions of a power box. For example, an electrical simulation of a circuit breaker may reset a determination of a tripping time when a load current changes. As such, the electrical simulation may model the tripping time longer than a real-world circuit breaker, which experiences changing load currents. Finding such issues in processing tools that are deployed in semiconductor fabs may be expensive and time-consuming. Further, diagnosing and solving such issues can involve a costly re-design of the power box.

Accordingly, examples are disclosed that relate to generating an electrical twin for a power system component. The electrical twin is for use in an electrical simulation to design the power box to stay within a constraint condition. Briefly, the disclosed examples build a computer implemented mechanical model of the power system component for a range of load currents and/or a range of ambient temperatures. The computer implemented mechanical model comprises a three-dimensional structural model of the power system component, including material and electrical characteristics of the power system component. Next, simulations are performed of the computer implemented mechanical model across the range of load currents and/or the range of ambient temperatures. Then, modeled physical data is generated for the power system component based on the simulations of the computer implemented mechanical model. The modeled physical data represent simulated physical states of the power system component under different physical conditions. Next, the electrical twin of the power system component is built based at least on the modeled physical data. Thus, the electrical twin relates physical states of the power system component to a range of ambient temperatures and/or a range of load currents. When used in an electrical simulation, the electrical twin can provide more accurate information on physical states for dynamic load currents and/or dynamic ambient temperatures than a static model. Performing electrical simulations utilizing the electrical twin may help to reduce a cost of designing and developing the power box. Further, such electrical simulations may be used as a diagnostic tool for power box behaviors in the field.

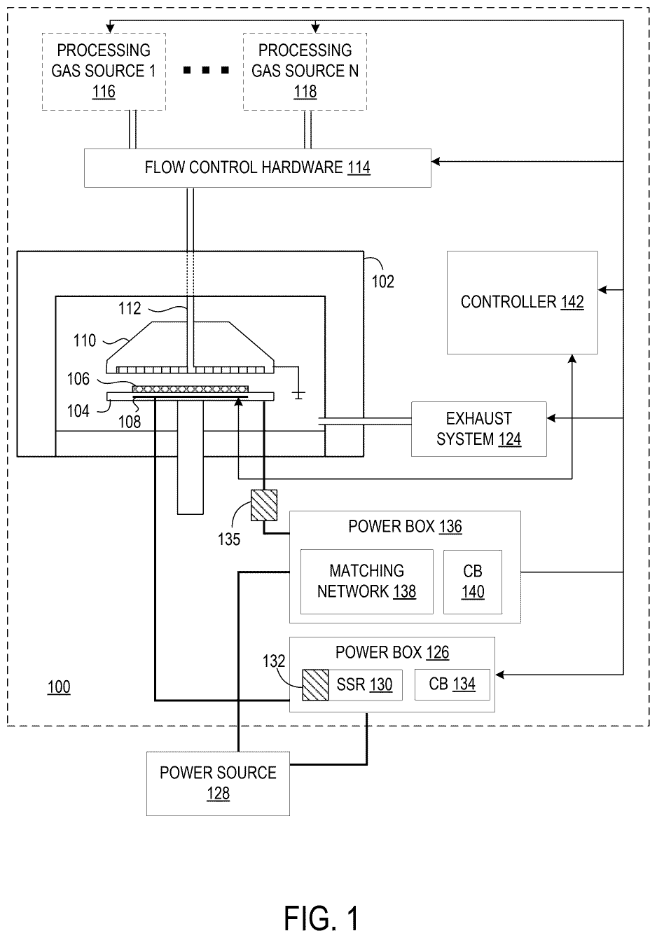

Prior to discussing these examples in detail, FIG. 1 schematically shows an example processing tool 100 utilizing power boxes to supply and/or control power to components of processing tool 100. Processing tool 100 takes the form of a deposition tool, such as a chemical vapor deposition (CVD) tool or atomic layer deposition (ALD) tool. In other examples, a processing tool comprising a power box designed according to the present disclosure can comprise any other suitable type of processing tool. Examples include electrodeposition tools, dry etching tools, wet etching tools, ultra-violet (UV) exposure tools, and spin clean tools.

Processing tool 100 comprises a processing chamber 102 and a substrate support 104 within processing chamber 102. Substrate support 104 is configured to support a substrate 106 disposed within processing chamber 102. Substrate support 104 includes a substrate heater 108. In other examples, a heater alternatively or additionally may be located elsewhere within processing chamber 102.

Processing tool 100 further comprises a showerhead 110, a gas inlet 112, and flow control hardware 114. In other examples, a processing tool may comprise a nozzle or other apparatus for supplying gas into processing chamber 102, as opposed to or in addition to a showerhead. Flow control hardware 114 is connected to one or more processing gas sources. The processing gas sources are illustrated as processing gas source 1 116 and processing gas source N 118, where N is an integer of 0 or greater.

Flow control hardware 114 can be controlled to flow gas from processing gas source 1 116 and processing gas source N into processing chamber 102 via gas inlet 112. Flow control hardware 114 may comprise one or more components controllable to place a selected gas source or selected gas sources in fluid connection with gas inlet 112. Example components of flow control hardware 114 include one or more mass flow controllers and/or valves. In some examples, a processing chamber may comprise one or more additional gas inlets.

Processing tool 100 further comprises an exhaust system 124. Exhaust system 124 is configured to exhaust gases from processing chamber 102. Exhaust system 124 may comprise any suitable hardware, including one or more pumps.

Processing tool 100 further comprises a first power box 126. First power box 126 is configured to receive power from a power source 128 and to provide an output power to substrate heater 108. First power box 126 comprises an SSR 130. SSR 130 is configured to be selectively controllable to switch the output power off and on using pulse-width modulation (PWM). Such a configuration may be used to control the temperature of substrate heater 108. However, switching the output power may increase a component temperature of SSR 130 during operation. As such, a heatsink 132 is thermally coupled to SSR 130. Heatsink 132 helps to dissipate heat generated by SSR 130 during switching. SSR 130 and heatsink 132 may be selected to stay within a constraint condition. For example, a size of heatsink 132 may be selected such that a component temperature of SSR 130 stays under a desired temperature.

First power box 126 further comprises a circuit breaker (CB) 134 comprising a bimetallic strip. The bimetallic strip deforms when circuit breaker 134 operates in a fault condition. When the deformation of the bimetallic strip meets a trip threshold condition, circuit breaker 134 operates as an open circuit. A duration that circuit breaker 134 remains in the fault condition before meeting the trip threshold condition, or tripping time, may vary depending on a load current and/or ambient temperature of circuit breaker 134. Circuit breaker 134 may be selected to stay within a constraint condition. For example, the constraint condition may comprise a desired tripping time for a desired load current and/or a desired ambient temperature.

Processing tool 100 further comprises a second power box 136 that powers a RF (radio frequency) generator 135. RF generator 135 is electrically connected to substrate support 104. RF generator 135 is configured to provide RF power to form a plasma. Showerhead 110 is configured as a grounded opposing electrode in this example. In other examples, RF generator 135 may supply RF power to showerhead 110, or to other suitable electrode structures. Second power box 136 includes a matching network 138 for impedance matching of the RF power. Examples of suitable powers include powers between 0 and 6500 watts. In some examples, the RF power is configured to operate at a plurality of different frequencies and/or powers. Second power box 136 further comprises a circuit breaker 140 comprising a bimetallic strip. Similar to circuit breaker 134, circuit breaker 140 operates as an open circuit when the bimetallic strip meets a trip threshold condition. In other examples, first power box 126 and second power box 136 may be combined into a single power box. In further examples, RF generator 135 and/or matching network 138 may be omitted.

The various components of first power box 126 and second power box 136 can be referred to generally as power system components. Power system components include SSR 130, circuit breaker 134, and circuit breaker 140, as examples. First power box 126 and/or second power box 136 also may comprise other power system components.

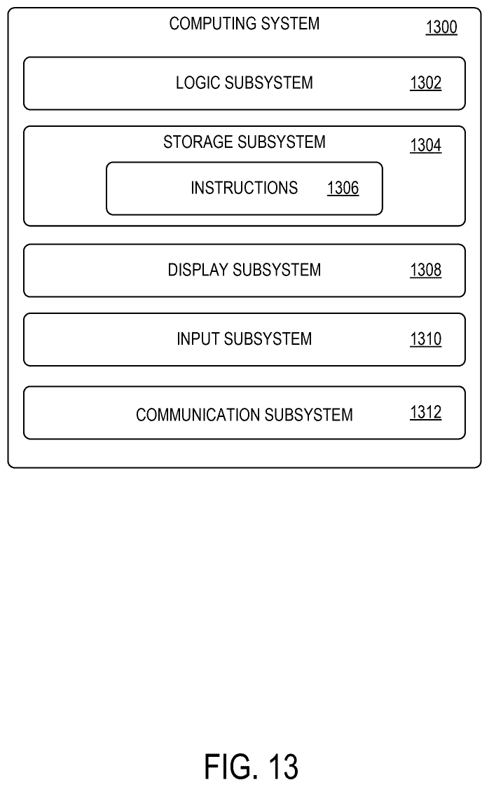

A controller 142 is operatively coupled to substrate heater 108, flow control hardware 114, exhaust system 124, first power box 126, and second power box 136. Controller 142 is configured to control various functions of processing tool 100 to perform a deposition process. For example, controller 142 is configured to control a temperature of substrate heater 108 by using PWM to control the switching of SSR 130. Controller 142 can adjust the PWM based on data from a temperature sensor to maintain a desired temperature on substrate heater 108. Controller 142 also is configured to operate flow control hardware 114 to flow a selected gas or mixture of gases at a selected rate into processing chamber 102. Controller 142 further is configured to operate exhaust system 124 to remove gases from processing chamber 102. Controller 142 may, for example, control exhaust system 124 and/or flow control hardware 114 to purge processing chamber 102. Furthermore, controller 142 is configured to operate RF generator 135 and second power box 136 to form a plasma in processing chamber 102. Controller 142 further may be configured to control any other suitable functions of processing tool 100. Controller 142 may comprise any suitable computing system, examples of which are described below with reference to FIG. 13.

As previously mentioned, electrical simulations can be used to help design a power box to stay within the constraint condition. However, available electrical simulations may not model electromechanical responses of the power system component under dynamic operating conditions. Instead, available simulations may use static modeling. As described above, static modeling may lead to design errors when modeling the behavior of electromechanical components in dynamic operating conditions.

Accordingly, as discussed above, the disclosed examples utilize an electrical twin of a power system component to perform an electrical simulation. The electrical twin relates physical states of the power system component to a range of ambient temperatures and/or a range of load currents. Th electrical simulation can include applying dynamic load currents and/or dynamic ambient temperatures to the electrical twin. The electrical twin can then determine corresponding physical states to generate electrical simulation results using the modeled physical data. Such electrical simulations can reflect real-world operating conditions of the power system component more than electrical simulations using static modeling.

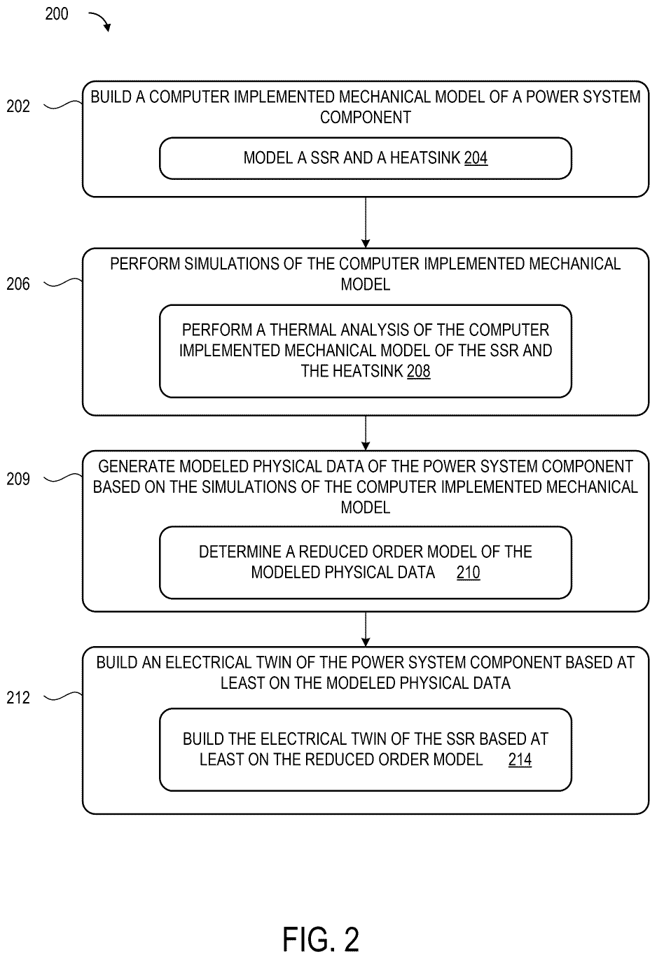

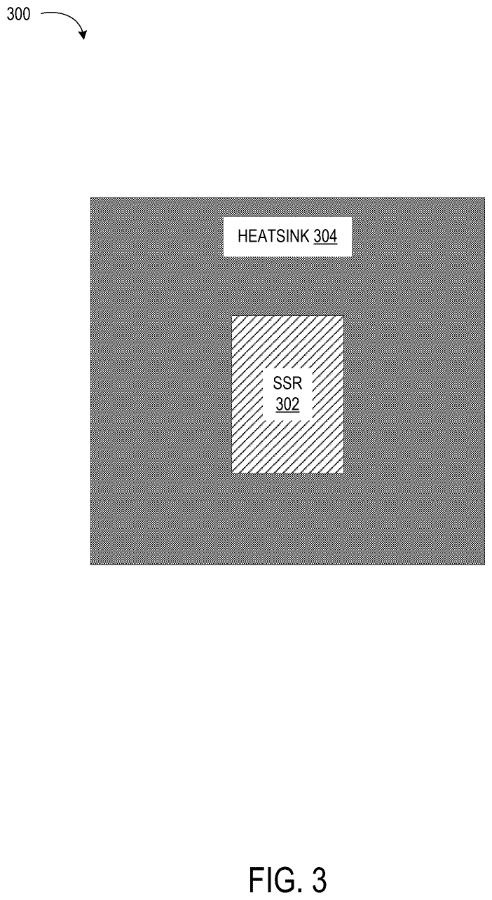

FIG. 2 depicts a flow diagram of an example method 200 for generating an electrical twin for a power system component of a power box. Method 200 comprises, at step 202, building a computer implemented mechanical model of the power system component for one or more of a range of load currents or a range of ambient temperatures. The computer implemented mechanical model may comprise structural data, electrical data, thermal data, or any combination thereof of the power system component. In the depicted example, the computer implemented mechanical model is configured to model a SSR and a heatsink, as indicated at 204. An example computer implemented mechanical model 300 is schematically illustrated in FIG. 3. As shown, a SSR 302 is thermally coupled to a heatsink 304. In such a configuration, heatsink 304 helps to dissipate heat generated from SSR 302. SSR 302 and heatsink 304 are examples of SSR 130 and heatsink 132, respectively. While FIG. 3 is depicted schematically, computer implemented mechanical model 300 comprises three-dimensional information regarding SSR 302 and heatsink 304. Computer implemented mechanical model 300 further comprises information regarding materials from which SSR 302 and heatsink 304 are made, including information on thermal conductivity of such materials.

Returning to FIG. 2, method 200 comprises, at step 206, performing simulations of the computer implemented mechanical model across the one or more of the range of load currents or the range of ambient temperatures. As depicted at 208, performing the simulations of the computer implemented mechanical model comprises performing a thermal analysis of the computer implemented mechanical model of the SSR and the heatsink across the one or more of the range of load currents or the range of ambient temperatures. The thermal analysis may determine heat generated by SSR 302 and dissipated by heatsink 304. The modeled physical data thus indicates a component temperature of SSR 302 arising from the one or more of the range of load currents or the range of ambient temperatures.

Method 200 comprises, at step 209, generating modeled physical data of the power system component based on the simulations of the computer implemented mechanical model. Method 200 further comprises, at step 210, optionally determining a reduced order model of the modeled physical data. For example, determining the reduced order model may comprise mathematically reducing the modeled physical data. In some examples, the reduced order model may comprise approximations of the modeled physical data, and thus, may be less complex than the modeled physical data. More specifically, the modeled physical data may comprise three-dimensional information. The three-dimensional information may be reduced to a two-dimensional perspective to determine the reduced order model. In such a manner, a runtime of a downstream electrical simulation using an electrical twin with the reduced order model may be less than using an electrical twin with the modeled physical data. In other examples, 210 may be omitted.

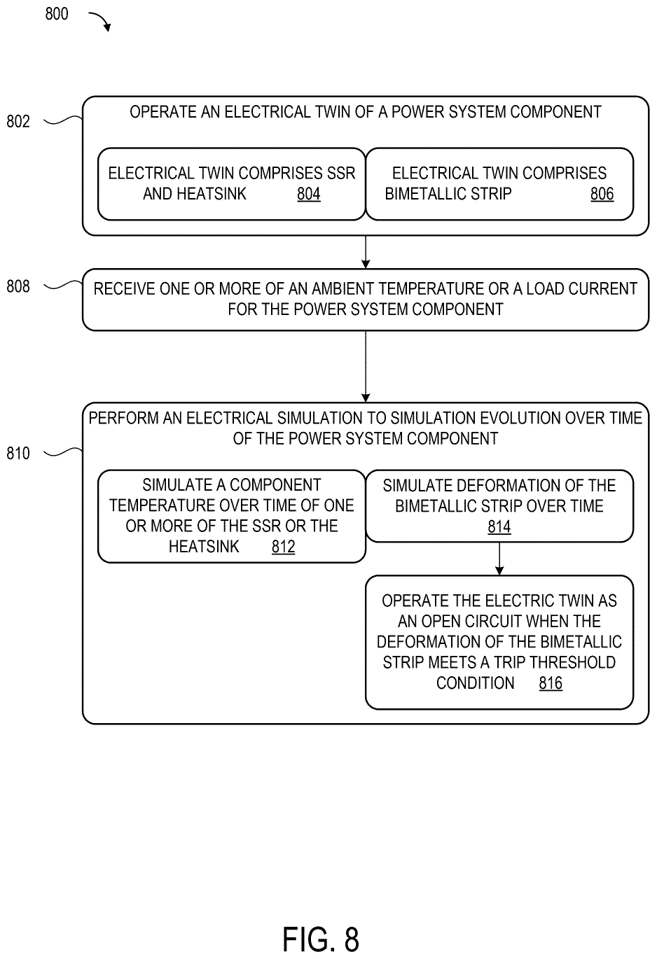

Method 200 further comprises, at step 212, building the electrical twin of the power system component based at least on the modeled physical data. The electrical twin of the power system component is for use in an electrical simulation to design the power box to stay within a constraint condition. An example use of the electrical twin in the electrical simulation is discussed below with reference to FIG. 8. In examples that comprise determining a reduced order model at step 210, building the electrical twin of the power system component based at least on the modeled physical data comprises building the electrical twin of the SSR based at least on the reduced order model, as indicated at 214.

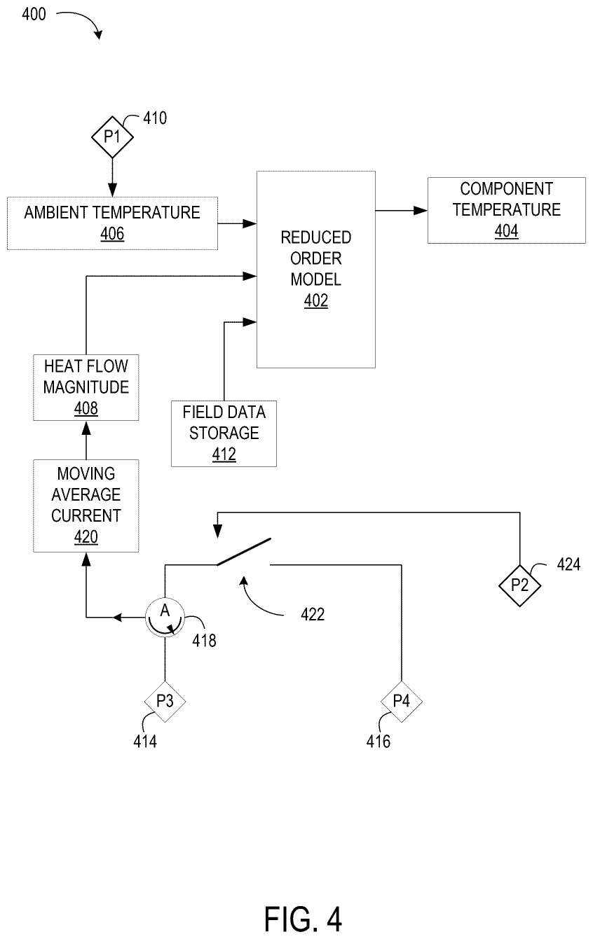

FIG. 4 schematically shows an example electrical twin 400 utilizing a computer implemented mechanical model of an SSR and a heatsink. Electrical twin 400 comprises a reduced order model 402. Reduced order model 402 is based on modeled physical data from a computer implemented mechanical model of the SSR, such as computer implemented mechanical model 300, for example. In other examples, reduced order model 402 may be based on any other suitable modeled physical data. Reduced order model 402 is configured to determine a component temperature 404 of an SSR based at least on an ambient temperature 406 and a heat flow magnitude 408 that arises from electrical current through the SSR. An input P1 410 is configured to receive ambient temperature 406. A field data storage 412 is configured to receive a rate at which to store data for an output of an electrical simulation. Heat flow magnitude 408 is based at least on a load current flowing from an input P3 414 to an output P4 416. Electrical twin 400 comprises a simulated current meter 418 to determine a moving average current (root-mean-square (RMS) Current) 420 of the load current. Moving average current 420 may comprise a RMS of the load current, for example. In other examples, other suitable calculations of the load current may be used. Electrical twin 400 determines heat flow magnitude 408 based at least on a power dissipated from the load current. More specifically, electrical twin 400 determines heat flow magnitude 408 by multiplying the RMS current of moving average current 420 and a corresponding voltage drop across the SSR.

Electrical twin 400 further comprises a switch 422 to model the SSR switching an output power on and off during operation. An input P2 424 controls switch 422 to open and close switch 422. An example use of electrical twin 400 in an electrical simulation is discussed below with reference to FIG. 8.

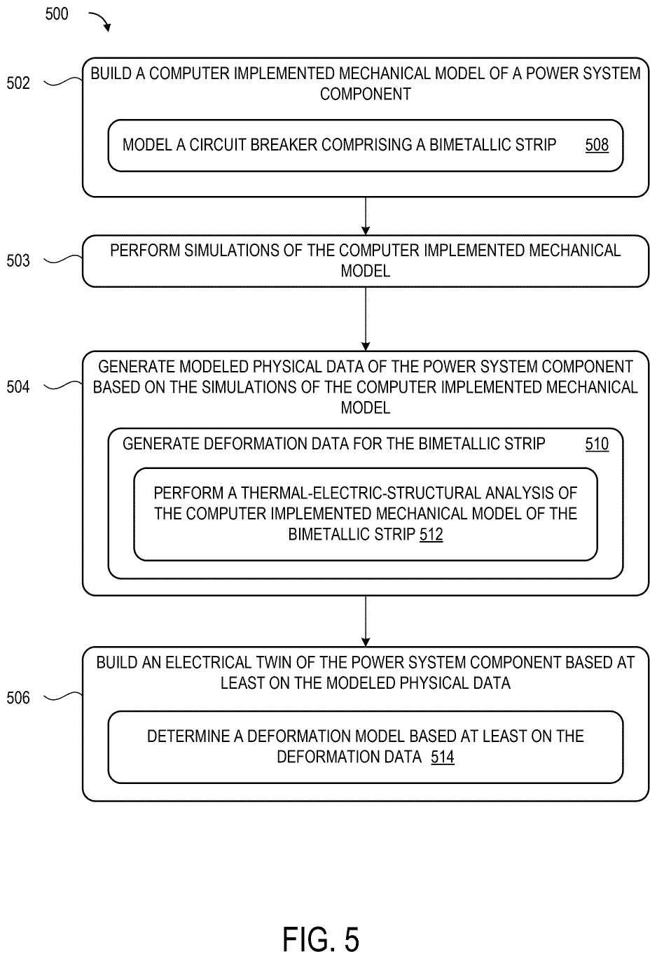

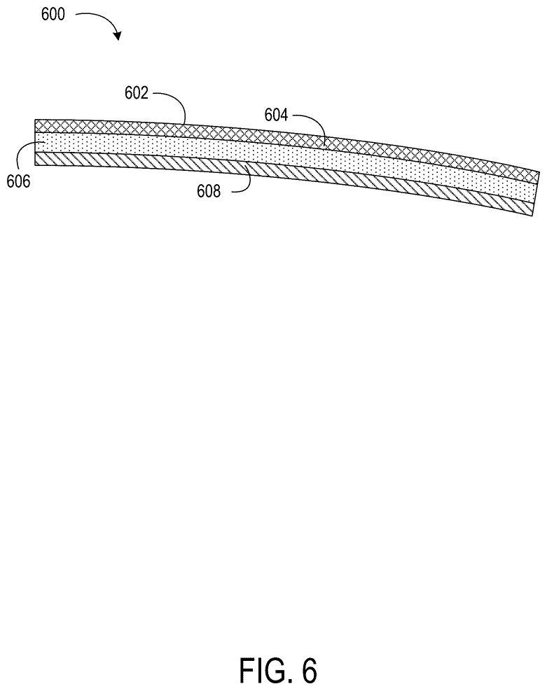

In the above examples, the modeled power system component comprises an SSR. In other examples, the modeled power system component can comprise a circuit breaker. FIG. 5 shows an example method 500 of generating an electrical twin for a circuit breaker, such as circuit breaker 134 or circuit breaker 140. Similar to method 200, method 500 comprises building, at step 502, a computer implemented mechanical model of a power system component. Method 500 further comprises performing, at step 503, simulations of the computer implemented mechanical model. Method 500 further comprises generating, at step 504, modeled physical data of the power system component based on the simulations of the computer implemented mechanical model. Method 500 additionally comprises building, at step 506, an electrical twin of the power system component based at least on the modeled physical data. In the depicted example, the computer implemented mechanical model comprises a model of a circuit breaker comprising a bimetallic strip, as indicated at 508. An example computer implemented mechanical model 600 of a bimetallic strip 602 is schematically illustrated in FIG. 6. As shown, bimetallic strip 602 comprises a first metal 604, a second metal 606, and an optional third metal 608. First metal 604, second metal 606, and third metal 608 can comprise alloys or pure metals in various examples. First metal 604, second metal 606, and third metal 608 comprise different thermal expansion coefficients. While FIG. 6 is depicted schematically, computer implemented mechanical model 600 comprises three-dimensional information of bimetallic strip 602. Computer implemented mechanical model 600 further comprises information regarding materials from which bimetallic strip 602 is made. For example, computer implemented mechanical model 600 includes information on thermal conductivity, electrical conductivity, and thermal expansion coefficients of the materials.

Returning to FIG. 5, generating the modeled physical data of the power system component comprises generating deformation data for the bimetallic strip across the one or more of the range of load currents or the range of ambient temperatures, as indicated at 510. Generating deformation data of the bimetallic strip can comprise performing a thermal-electric-structural analysis of the computer implemented mechanical model of the bimetallic strip across the one or more of the range of load currents or the range of ambient temperatures, as indicated at 512. In such a manner, the modeled physical data indicates a rate of deformation of the bimetallic strip arising from combinations of load currents and ambient temperatures within the range of load currents and/or the range of ambient temperatures.

Continuing, building the electrical twin of the power system component based at least on the modeled physical data comprises determining a deformation model based at least on the deformation data, as indicated at 514. The deformation model indicates at least rates of deformation of the bimetallic strip across the range of load currents. The deformation model can then be used in an electrical twin of the circuit breaker.

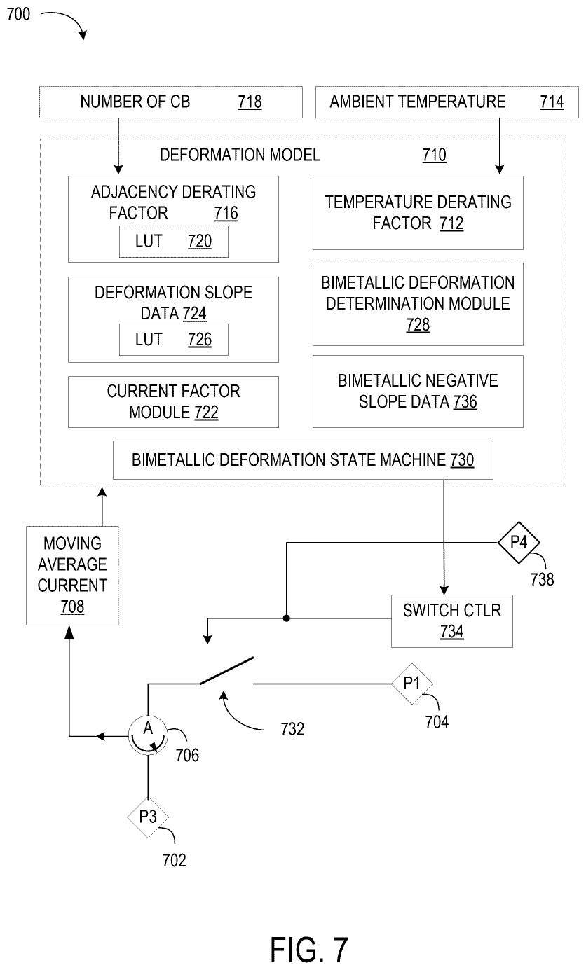

FIG. 7 shows an example electrical twin 700 of a circuit breaker comprising a bimetallic strip, such as bimetallic strip 602 for example. Electrical twin 700 is configured to simulate electrical behavior of a circuit breaker at different ambient temperatures and load currents. In electrical twin 700, a load current flows from an input P3 702 to an output P1 704. A simulated current meter 706 determines a moving average current, such as a root-mean-square current (RMS current) 708 of the load current.

Electrical twin 700 further comprises a deformation model 710. Deformation model 710 is configured to determine when the circuit breaker is operating in a fault condition based at least on moving average current (RMS current) 708. As previously mentioned, a fault condition indicates that a load current is greater than a rated current of the circuit breaker. However, the rated current may be derated based on operating conditions of the circuit breaker. Thus, electrical twin 700 comprises a temperature derating factor 712 to determine a derated current by derating the rated current based on an ambient temperature 714. As a specific example, a rated current of 40 A (amperes) at 30 C (Celsius) can be derated to 38 A at 40 C. Similarly, an adjacency derating factor 716 can be used to further derate the rated current based on number of circuit breakers 718. As a specific example, a single circuit breaker at 40 C is rated at 100%, whereas two adjacent circuit breakers at 40 C are each derated to 90%. In some examples, adjacency derating factor 716 may utilize a look-up table LUT 720 to determine a derated current. Ambient temperature 714 and a number of adjacent circuit breakers 718 are configurable inputs to electrical twin 700. Electrical twin 700 further comprises a current factor module 722 configured to determine when the circuit breaker is operating in the fault condition based at least on moving average current (RMS current) 708 and the derated current.

Deformation model 710 is configured to determine a bimetallic deformation magnitude when the circuit breaker is operating in the fault condition. When in the fault condition, deformation slope data 724 is used to determine a rate of deformation of the bimetallic strip based on moving average current (RMS current) 708 utilizing look-up table LUT 726. In some examples, deformation slope data 724 may be used to interpolate between two or more entries of LUT 726 to determine the rate of deformation. Such interpolation can help to reduce a size of LUT 726.

A bimetallic deformation determination module 728 is configured to determine the bimetallic deformation magnitude based at least on the rate of deformation. Further, a bimetallic deformation state machine 730 is configured to determine when the bimetallic deformation magnitude meets a trip threshold condition. Bimetallic deformation state machine 730 sends an output to a switch controller 734 indicating when the determined bimetallic deformation magnitude meets the trip threshold condition. In some examples, the trip threshold condition comprises a deformation magnitude greater than a specified deformation magnitude. The depicted functions of deformation model 710 are illustrative, and in other examples, a model for determining when the bimetallic strip meets a trip threshold condition can comprise any other suitable structure.

As previously mentioned, a circuit breaker operates as an open circuit when the bimetallic strip meets the trip threshold condition. Thus, electrical twin 700 comprises a switch 732. Switch controller 734 is configured to open switch 732 to create an open circuit based on the output from bimetallic deformation state machine 730. When switch 732 is open, bimetallic deformation determination module 728 is configured to determine the bimetallic deformation magnitude using bimetallic negative slope data 736. In some examples, the bimetallic negative slope data 736 may be stored in a look-up table.

Electrical twin 700 further comprises an output P4 738. Output P4 738 can indicate a status of switch 732. In such a manner, electrical twin 700 is configured to relate physical states of deformation of a bimetallic strip to the range of load currents and/or the range of ambient temperatures.

Electrical twin 700 of FIG. 7 is illustrative, and any other suitable electrical twin configuration may be used to model a circuit breaker in dynamic operation. While the above examples are given for an SSR and a circuit breaker, other power system components may be modeled using an electrical twin in other examples.

The above examples relate to generating electrical twins of power system components. Such electrical twins can be used for designing a power box to stay within a constraint condition. FIG. 8 illustrates a flow diagram of an example method 800 for simulating a power box utilizing an electrical twin of a power system component. Method 800 comprises, at step 802, operating an electrical twin of a power system component. The electrical twin relates physical states of the power system component to one or more of a range of ambient temperatures or a range of load currents. In some examples, the electrical twin comprises an electrical twin of a SSR and a heatsink, as indicated at 804.

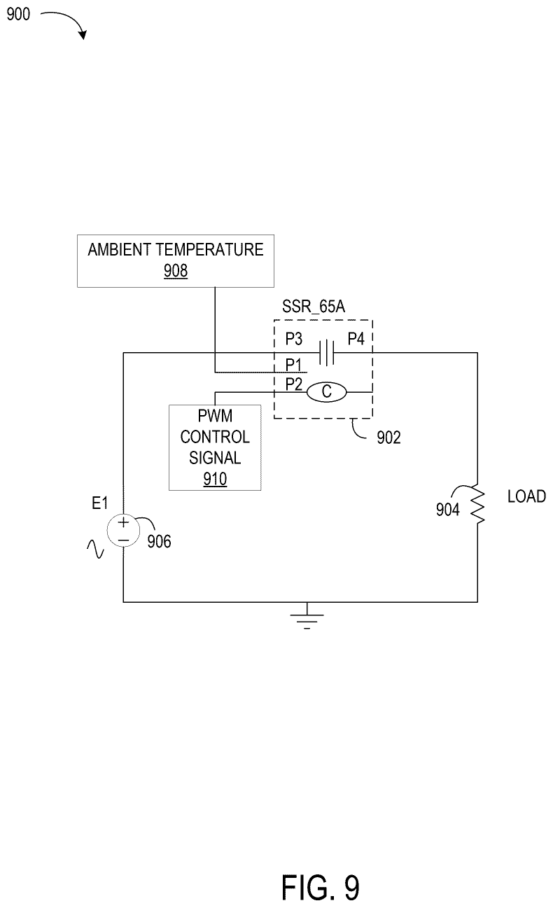

In such examples, an electrical simulation may utilize the electrical twin of the SSR and the heatsink to help design a power box to stay within a constraint condition. FIG. 9 schematically shows such an electrical simulation 900. Electrical simulation 900 comprises an electrical twin 902 of an SSR and a heatsink. Electrical twin 902 is an example implementation of electrical twin 400. In the depicted example, the SSR comprises an SSR rated for 65 A. In other examples, electrical twin can comprise any other suitable SSR and/or heatsink. Electrical twin 902 is connected to a load 904 (depicted as a resistor) and a voltage source 906. Load 904 and voltage source 906 help to drive a load current through electrical twin 902. An ambient temperature 908 and a PWM control signal 910 are configured as controllable inputs to electrical simulation 900. More specifically, ambient temperature 908 and PWM control signal 910 are applied to electrical twin 902. Electrical simulation 900 of FIG. 9 is illustrative, and other electrical simulations utilizing electrical twin 902 may be used in other examples.

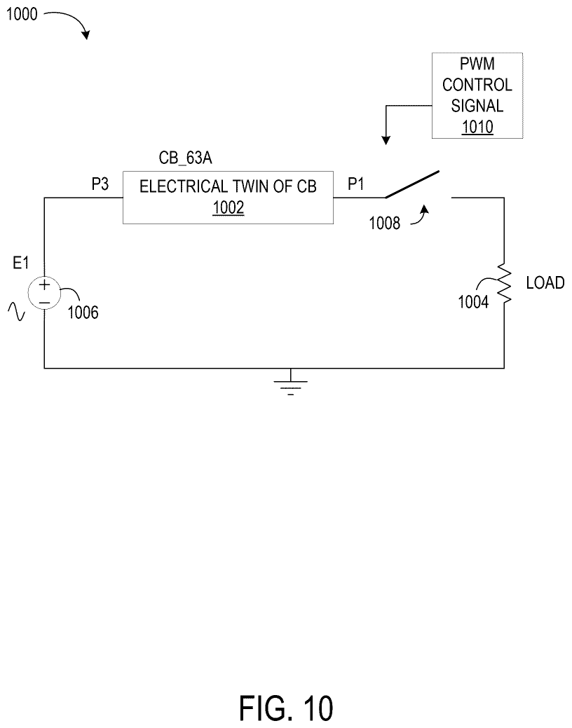

Returning to FIG. 8, in other examples, the electrical twin comprises an electrical twin of a circuit breaker comprising a bimetallic strip, as indicated at 806. FIG. 10 schematically shows an example electrical simulation 1000 comprising an electrical twin 1002 of a circuit breaker. Electrical twin 1002 is an example implementation of electrical twin 700. In the depicted example, electrical twin 1002 comprises a circuit breaker rated for 63 A. In other examples, electrical twin 1002 can comprise other circuit breakers. Electrical simulation 1000 further comprises a load 1004 (depicted as a resistor) and a voltage source 1006 to generate a load current. A switch 1008 is configured to utilize a PWM control signal 1010 to control the amount of load current through electrical twin 1002. Electrical simulation 100 of FIG. 10 is illustrative and other electrical simulations utilizing electrical twin 1002 may be used in other examples. Returning to FIG. 8, in further examples, the electrical twin can model other power system components than a SSR and heatsink or a circuit breaker.

Method 800 further comprises, at step 808, receiving one or more of an ambient temperature or a load current for the power system component. Method 800 next comprises, at step 810, performing an electrical simulation to simulate evolution over time of the power system component for the one or more of the ambient temperature or the load current. In the examples where the electrical twin comprises an electrical twin of the SSR and the heatsink, method 800 comprises, at step 812, simulating a component temperature over time of one or more of the SSR or the heatsink.

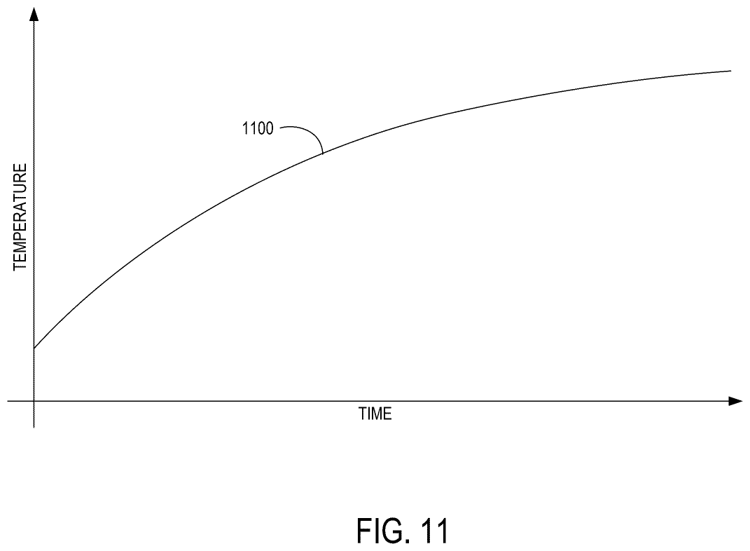

FIG. 11 schematically illustrates an example component temperature 1100 of an SSR over time, such as simulated by electrical simulation 900, for example. In some examples, the SSR and the heatsink in the electrical simulation are selected to stay under a desired temperature. Such a configuration may help to increase a reliability of the SSR and the heatsink over an SSR and a heatsink with a component temperature over the desired temperature. Thus, by using an electrical simulation utilizing an electrical twin as disclosed, a power box can be designed to stay within a constraint condition. In the example of FIG. 11, the power box can be designed to stay under a desired temperature. FIG. 11 is illustrative, and other component temperatures of an SSR and/or heatsink may be simulated.

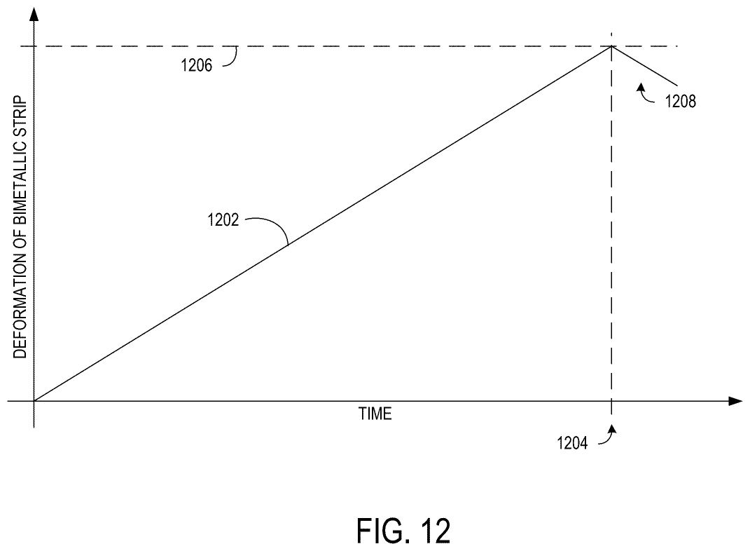

Returning to FIG. 8, in examples where the electrical twin comprises the electrical twin of the circuit breaker, method 800 comprises, at step 814, simulating deformation of the bimetallic strip over time for the ambient temperature and the load current. Further, at step 816, method 800 comprises operating the electrical twin as an open circuit when the deformation of the bimetallic strip meets a trip threshold condition. FIG. 12 schematically illustrates an example deformation over time of a circuit breaker when the circuit breaker is in a fault condition. FIG. 12 may be generated by the electrical simulation of FIG. 10, for example. As shown, a deformation 1202 of a bimetallic strip of the circuit breaker increases over time when the circuit breaker is in a fault condition. At time 1204, deformation 1202 meets a trip threshold condition 1206. In the depicted example, trip threshold condition 1206 comprises a specified deformation magnitude. Further, at time 1204, the circuit breaker operates as an open circuit. As previously mentioned, when the circuit breaker operates as the open circuit, bimetallic negative slope data is used to determine deformation 1202, as indicated at 1208. FIG. 12 is illustrative and other tripping times of a circuit breaker may be simulated.

In such a manner, method 800 performs an electrical simulation to simulate evolution over time of a physical state of the power system component. The electrical simulation may be used to design a power box to stay within a constraint condition. Using an electrical simulation to select a power system component as disclosed can help to avoid problems that arise when performing static simulations of power system components. Further, an electrical simulation as disclosed also can be used to help troubleshoot power box problems in existing processing tools. This may help to identify power box problems more quickly and efficiently than by other diagnostic methods. While examples are given for a SSR and a circuit breaker, any other electromechanical power system components can be modeled in a similar manner.

In some embodiments, the methods and processes described herein can be tied to a computing system of one or more computing devices. In particular, such methods and processes can be implemented as a computer-application program or service, an application-programming interface (API), a library, and/or other computer-program product. FIG. 13 schematically shows an example of a computing system 1300 that can enact one or more of the methods and processes described above. Computing system 1300 is shown in simplified form. Computing system 1300 can take the form of one or more personal computers, server computers, tablet computers, network computing devices, and/or other computing devices. Controller 142 is an example of computing system 1300. Method 200, method 500, method 800 can be performed by computing system 1300. More specifically, computing system 1300 can use computer implemented mechanical models 300, 600 to generate electrical twins 400, 700, respectively. Further, computing system 1300 can perform simulations using electrical simulation 900 and/or 1000.

Computing system 1300 includes a logic subsystem 1302 and a storage subsystem 1304. Computing system 1300 can optionally include a display subsystem 1308, input subsystem 1310, communication subsystem 1312, and/or other components not shown in FIG. 13.

Logic subsystem 1302 includes one or more physical devices configured to execute instructions 1306. For example, the logic subsystem can be configured to execute instructions that are part of one or more applications, services, programs, routines, libraries, objects, components, data structures, or other logical constructs. Such instructions can be implemented to perform a task, implement a data type, transform the state of one or more components, achieve a technical effect, or otherwise arrive at a desired result. As examples, logic subsystem can execute instructions to implement method 200, method 500, and method 800.

The logic subsystem can include one or more processors configured to execute software instructions. Additionally or alternatively, the logic subsystem can include one or more hardware or firmware logic devices configured to execute hardware or firmware instructions. Processors of the logic subsystem can be single-core or multi-core, and the instructions executed thereon can be configured for sequential, parallel, and/or distributed processing. Individual components of the logic subsystem optionally can be distributed among two or more separate devices, which can be remotely located and/or configured for coordinated processing. Aspects of the logic subsystem can be virtualized and executed by remotely accessible, networked computing devices configured in a cloud-computing configuration.

Storage subsystem 1304 includes one or more physical devices configured to hold instructions 1306 executable by the logic subsystem to implement the methods and processes described herein. For example, storage subsystem 1304 can comprise instructions executable to perform method 200, method 500, and/or method 800. When such methods and processes are implemented, the state of storage subsystem 1304 can be transformed—e.g., to hold different data.

Storage subsystem 1304 can include removable and/or built-in devices. Storage subsystem 1304 can include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1304 can include volatile, nonvolatile, dynamic, static, read/write, read-only, random-access, sequential-access, location-addressable, file-addressable, and/or content-addressable devices.

It will be appreciated that storage subsystem 1304 includes one or more physical devices. However, aspects of the instructions described herein alternatively can be propagated by a communication medium (e.g., an electromagnetic signal, an optical signal, etc.) that is not held by a physical device for a finite duration.

Aspects of logic subsystem 1302 and storage subsystem 1304 can be integrated together into one or more hardware-logic components. Such hardware-logic components can include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1308 can be used to present a visual representation of data held by storage subsystem 1304. This visual representation can take the form of a graphical user interface (GUI). As the herein described methods and processes change the data held by the storage subsystem, and thus transform the state of the storage subsystem, the state of display subsystem 1308 can likewise be transformed to visually represent changes in the underlying data. Display subsystem 1308 can include one or more display devices utilizing virtually any type of technology. Such display devices can be combined with logic subsystem 1302 and/or storage subsystem 1304 in a shared enclosure, or such display devices can be peripheral display devices.

When included, input subsystem 1310 can comprise one or more user-input devices such as a keyboard, mouse, or touch screen. In some embodiments, the input subsystem can comprise or interface with selected natural user input (NUI) componentry. Such componentry can be integrated or peripheral, and the transduction and/or processing of input actions can be handled on- or off-board.

When included, communication subsystem 1312 can be configured to communicatively couple computing system 1300 with one or more other computing devices. Communication subsystem 1312 can include wired and/or wireless communication devices compatible with one or more different communication protocols. As examples, the communication subsystem can be configured for communication using a wireless telephone network, or a wired or wireless local- or wide-area network. In some embodiments, the communication subsystem can allow computing system 1300 to send and/or receive messages to and/or from other devices using a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

“And/or” as used herein is defined as the inclusive or v, as specified by the following truth table:

| A | B | A ∨ B |
|---|---|---|
| True | True | True |
| True | False | True |
| False | True | True |
| False | False | False |

The terminology “one or more of A or B” as used herein comprises A, B, or a combination of A and B. The terminology “one or more of A, B, or C” is equivalent to A, B, and/or C. As such, “one or more of A, B, or C” as used herein comprises A individually, B individually, C individually, a combination of A and B, a combination of A and C, a combination of B and C, or a combination of A, B and C.

It will be understood that the configurations and/or approaches described herein are exemplary in nature, and that these specific embodiments or examples are not to be considered in a limiting sense, because numerous variations are possible. The specific routines or methods described herein may represent one or more of any number of strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of generating an electrical twin for a power system component of a power box, the method comprising:
building a computer implemented mechanical model of the power system component for one or more of a range of load currents or a range of ambient temperatures;
performing simulations of the computer implemented mechanical model across the one or more of the range of load currents or the range of ambient temperatures;
generating modeled physical data of the power system component based on the simulations of the computer implemented mechanical model; and
building the electrical twin of the power system component based at least on the modeled physical data.

2. The method of claim 1, wherein the computer implemented mechanical model is configured to model a solid-state relay (SSR) and a heatsink.

3. The method of claim 2, wherein performing the simulations of the computer implemented mechanical model across the one or more of the range of load currents or the range of ambient temperatures comprises performing a thermal analysis of the computer implemented mechanical model of the SSR and the heatsink across the one or more of the range of load currents or the range of ambient temperatures.

4. The method of claim 2, further comprising determining a reduced order model of the modeled physical data, and wherein building the electrical twin of the power system component based at least on the modeled physical data comprises building the electrical twin of the SSR based at least on the reduced order model.

5. The method of claim 1, wherein the computer implemented mechanical model comprises a model of a circuit breaker comprising a bimetallic strip.

6. The method of claim 5, wherein generating the modeled physical data of the power system component comprises generating deformation data of the bimetallic strip across the one or more of the range of load currents or the range of ambient temperatures.

7. The method of claim 6, wherein generating deformation data of the bimetallic strip comprises performing a thermal-electric-structural analysis of the computer implemented mechanical model of the bimetallic strip across the one or more of the range of load currents or the range of ambient temperatures.

8. The method of claim 6, wherein building the electrical twin of the power system component based at least on the modeled physical data comprises determining a deformation model based at least on the deformation data, the deformation model indicating at least rates of deformation across the range of load currents.

9. A computing system, comprising:
a logic subsystem; and
a storage subsystem comprising instructions executable by the logic subsystem to
operate an electrical twin of a power system component, the electrical twin relating physical states of the power system component to one or more of a range of ambient temperatures or a range of load currents,
receive one or more of an ambient temperature or a load current for the power system component, and
perform an electrical simulation to simulate evolution over time of the power system component for the one or more of the ambient temperature or the load current.

10. The computing system of claim 9, wherein the electrical twin comprises an electrical twin of a solid-state relay (SSR) and a heatsink.

11. The computing system of claim 10, wherein the instructions executable to perform the electrical simulation to simulate evolution over time of the power system component comprise instructions to simulate a component temperature over time of one or more of the SSR or the heatsink.

12. The computing system of claim 9, wherein the electrical twin comprises an electrical twin of a circuit breaker comprising a bimetallic strip.

13. The computing system of claim 12, wherein the instructions executable to perform the electrical simulation to simulate evolution over time of the power system component comprise instructions to simulate deformation of the bimetallic strip over time for the ambient temperature and the load current.

14. The computing system of claim 13, wherein the instructions executable to use the electrical twin in the electrical simulation to simulate evolution over time further comprise instructions to operate the electrical twin as an open circuit when the deformation of the bimetallic strip meets a trip threshold condition.

15. A method to simulate a power box, the method comprising:
operating an electrical twin of a power system component, the electrical twin relating physical states of the power system component to one or more of a range of ambient temperatures or a range of load currents,
receiving one or more of an ambient temperature or a load current for the power system component, and
performing an electrical simulation to simulate evolution over time of the power system component for the one or more of the ambient temperature or the load current.

16. The method of claim 15, wherein the electrical twin comprises an electrical twin of a solid-state relay (SSR) and a heatsink.

17. The method of claim 16, wherein performing the electrical simulation to simulate evolution over time of the power system component comprises simulating a component temperature over time of one or more of the SSR or the heatsink.

18. The method of claim 15, wherein the electrical twin comprises an electrical twin of a circuit breaker comprising a bimetallic strip.

19. The method of claim 18, wherein performing the electrical simulation to simulate evolution over time of the power system component comprises simulating deformation of the bimetallic strip over time for the ambient temperature and the load current.

20. The method of claim 19, wherein performing the electrical simulation to simulate evolution over time of the power system component comprises operating the electrical twin as an open circuit when the deformation of the bimetallic strip meets a trip threshold condition.
